(19) United States
(12) Patent Application Publication
(10) Pub. No.: US 2020/0073394 A1
(43) Pub. Date: Mar. 5, 2020

(54) SELF-TRAVELING DEVICE AND SELF-TRAVELING DEVICE SYSTEM

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Masato Igarashi, Kawasaki Kanagawa (JP)

(21) Appl. No.: 16/286,354

(22) Filed: Feb. 26, 2019

(30) Foreign Application Priority Data
Sep. 3, 2018 (JP) 2018-164693

(51) Int. Cl. G05D 1/02; H04B 5/00; G05D 1/00; G06K 7/10

(52) U.S. Cl. CPC G05D 1/028; H04B 5/0056; G06K 7/10366; G05D 1/0231; G05D 1/0011

(57) ABSTRACT

A self-traveling device propelled by a motor includes a tag reader/writer configured to communicate with a wireless tag, and a processor configured to control the motor to propel the device toward a position where the wireless tag is placed, when the device reaches the position, in response to receipt of an operation program from the wireless tag through the tag reader/writer, interpret a command included in the operation program, and execute the interpreted command before controlling the motor to propel the device toward another position where another wireless tag is placed.

### CROSS-REFERENCE TO RELATED APPLICATION

This application is based upon and claims the benefit of priority from Japanese Patent Application No. 2018-164693, filed Sep. 3, 2018, the entire contents of which are incorporated herein by reference.

### FIELD

Embodiments described herein relate generally to a self-traveling device and a self-traveling device system.

### BACKGROUND

In order to control a self-traveling robot, a software program is prepared by using a personal computer (hereinafter referred to as a PC) in advance, and is uploaded to the robot. A plurality of commands for various operations of the robot can be included in the operation program. However, when the operations are required to be changed, the operation program has to be rewritten and uploaded to the robot again.

On the other hand, a self-traveling robot having a bar-code reader has been proposed. The self-traveling robot reads a bar-code and operates according to the command indicated by the bar-code. However, the number of commands that can be indicated by the barcode is limited, and thus the robot can only perform a simple operation.

### DESCRIPTION OF THE DRAWINGS

FIG. 1 is a diagram explaining a basic movement of a self-traveling robot according to an embodiment.

FIG. 2 is a plan view of the self-traveling robot according to the embodiment.

FIG. 3 is a view of a bottom surface of the self-traveling robot according to the embodiment.

FIG. 4 is a block diagram illustrating a configuration of a hardware circuit of the self-traveling robot according to the embodiment.

FIG. 5 is a configuration diagram of an internal software program for a robot control unit of the self-traveling robot according to the embodiment.

FIG. 6 is a flowchart of a basic operation of the self-traveling robot according to the embodiment.

FIG. 7 is a sequence diagram of messaging between a near field wireless communication reader/writer circuit of a near field wireless communication tag, a robot control unit, and a crawler drive circuit.

FIG. 8 is a diagram illustrating a data structure of tag data stored in the near field wireless communication tag according to the embodiment.

FIG. 9 is a diagram illustrating a list of commands according to the embodiment.

FIG. 10 is a diagram illustrating a list of operators according to the embodiment.

FIG. 11 is a diagram illustrating a list of control syntax according to the embodiment.

FIG. 12 is a diagram illustrating definitions of usable variables and arrays according to the embodiment.

FIG. 13 is a diagram illustrating an operation program according to the embodiment.

FIG. 14 is a diagram illustrating a size-declared array according to the embodiment.

FIG. 15 is a diagram illustrating a data structure of a near field wireless communication tag used in a tag for reading and writing data to and from a near field wireless communication tag according to the embodiment.

FIG. 16 is a diagram illustrating load and store commands according to the embodiment.

FIG. 17 is a diagram illustrating an arrangement of a plurality of near field wireless communication tags according to the embodiment.

FIG. 18 is a diagram illustrating an operation program written into a program tag according to the embodiment.

### DETAILED DESCRIPTION

Embodiments provide a self-traveling device and a self-traveling device system capable of performing complicated operations without downloading an operation program.

In general, according to one embodiment, a self-traveling device propelled by a motor includes a tag reader/writer configured to communicate with a wireless tag, and a processor configured to control the motor to propel the device toward a position where the wireless tag is placed, when the device reaches the position, in response to receipt of an operation program from the wireless tag through the tag reader/writer, interpret a command included in the operation program, and execute the interpreted command before controlling the motor to propel the device toward another position where another wireless tag is placed.

Hereinafter, an embodiment will be described with reference to the drawings.

### Configuration

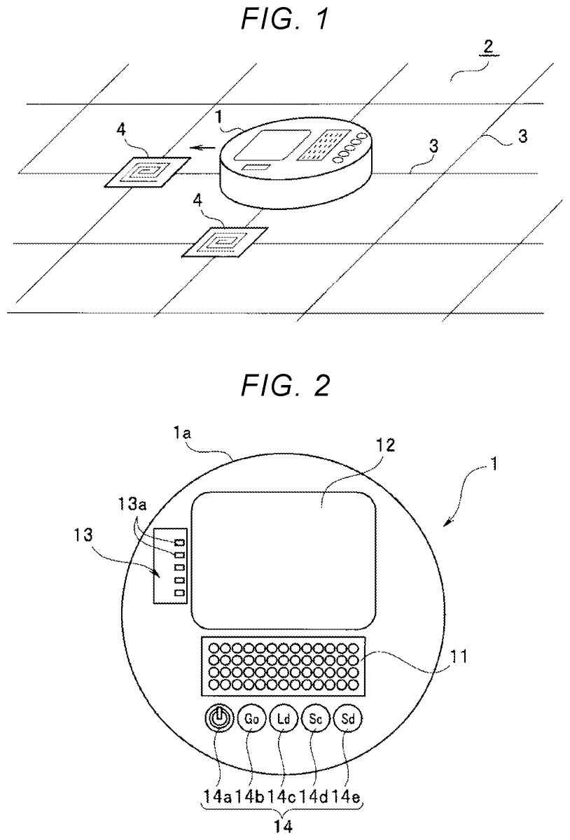

FIG. 1 is a diagram explaining a basic movement of a self-traveling robot in the embodiment. A self-traveling robot (hereinafter, simply referred to as a robot) 1 is a self-traveling device that is placed on a field 2 such as a floor, detects grid lines 3 written on the field 2, and can move along the grid lines 3. For example, the grid lines 3 are formed on the field 2 by sticking linear tape or painting lines with paint.

That is, the grid lines 3 are drawn on the field 2 where the robot 1 travels. The grid lines 3 define predetermined paths through which the robot 1 moves within a predetermined area on the field 2. The robot 1 can travel along a grid line 3 while reading the grid line 3 using a light sensor described later.

Here, the grid line 3 includes a plurality of horizontal lines parallel to each other and a plurality of vertical lines in a direction perpendicular to the plurality of horizontal lines.

As described above, the predetermined path of the robot to move is defined by the grid line 3 formed on a two-dimensional plane.

A near field wireless communication (near field communication: hereinafter, referred to as NFC) tag (hereinafter, referred to as an NFC tag) 4 is disposed on any of the plurality of intersections of the horizontal lines and the vertical lines of the grid lines 3. As will be described later, the robot 1 can read an operation program written in the NFC tag 4 and can perform an operation based on the command included in the operation program.

A self-traveling device system includes the robot 1 and the plurality of NFC tags 4.

Specifically, the robot 1 is guided by the grid line 3 and moves to a position where the operation program can be read from the NFC tag 4. The robot 1 reads the operation program from the NFC tag 4 using an NFC reader/writer provided on the bottom surface of a main body 1a to be described later, and executes the operation program. The operation program includes a plurality of commands specifying the operation or processing for the robot 1.

For example, the robot 1 performs traveling forward and turning based on the operation program. The robot 1 can perform traveling forward, traveling backward, rotating, and the like using a pair of crawlers provided on the bottom surface of the main body 1a. The robot 1 can change the traveling direction based on the operation program by rotating to the right or left at an intersection of grid lines 3.

In the present embodiment, using a pair of crawlers is an example of a structure for moving the robot 1, but the moving mechanism is not limited to the pair of crawlers, but a mechanism using a plurality of wheels or the like may be used.

That is, the robot 1 is a self-traveling device which moves upon reading the operation program from the outside through the near field communication.

FIG. 2 is a plan view of the robot 1. The robot 1 has a cylindrical shape. A keyboard 11, a display 12, an indicator unit 13, and a button unit 14 are disposed on a circular top surface of the main body 1a of the robot 1.

The keyboard 11 is an input device by which the user inputs a command and data for the program.

The display 12 is a display device such as a liquid crystal display, and displays an operation program and the like.

The indicator unit 13 includes a plurality of lamps 13a, and indicates the state of the robot 1 and the like by turning on, turning off and blinking the lamp or the like. The indicator unit 13 indicates a power supply state (e.g., ON or OFF state), an NFC tag detection state (e.g., detecting or non-detecting state), a program execution state (e.g., execution or non-execution state), a program execution error state, and a tag error state (e.g., reading or writing error state).

The button unit 14 includes a plurality of buttons; here they are a power source button 14a, a program execution button (Go) 14b, a tag read button (Ld) 14c, a tag write button (Sc) 14d for program, a tag write button (Sd) 14e for data.

The robot 1 reads the program and the data from the NFC tag 4 when the user operates the tag read button (Ld) 14c.

The robot 1 stores the input program in the NFC tag 4 when the user operates the tag writing button (Sc) 14d.

The robot 1 stores the input data in the NFC tag 4 when the user operates the tag write button (Sd) 14e.

Accordingly, the user may input the operation program and the data into the robot 1 using the keyboard 11 while viewing and editing the operation program and the data displayed on the display 12. For example, when the user inputs a program code using the keyboard 11, the input operation program code is displayed on the display 12.

The user may further input the program code and edit program code while viewing the displayed operation program. The created operation program is written into the NFC tag 4.

Therefore, the keyboard 11 and the display 12 are user interfaces for inputting the operation program, and the operation program is written into the NFC tag 4 by the NFC reader/writer circuit 22 to be described later.

The user may input the operation program and the data to be stored in the NFC tag 4 using the robot 1. However, the operation program and the data may be created using a PC or the like and then may be written into the NFC tag 4 using another device.

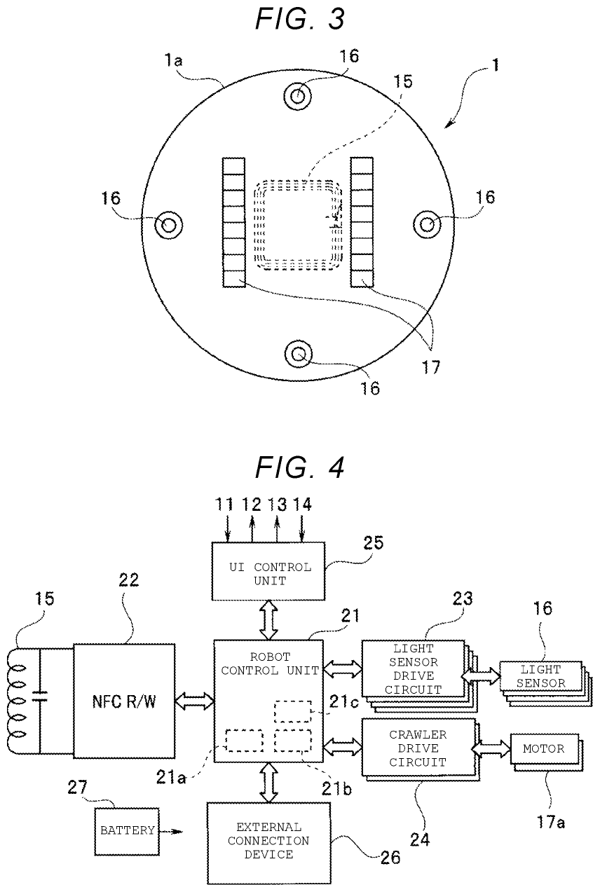

FIG. 3 is a view of a bottom surface of the self-traveling robot 1. An antenna 15 for the NFC reader/writer is built in the vicinity of a center part of the circular bottom surface of the main body 1a. That is, the antenna 15 for the NFC reader/writer is disposed under the main body 1a. The antenna 15 may be disposed so as to be exposed at the bottom surface of the main body 1a.

On the bottom surface of the main body 1a, four light sensors 16 are disposed around the center of the circular bottom surface, spaced at 90 degrees. Each light sensor 16 is an image sensor such as a CMOS image sensor.

Each light sensor 16 is a sensor for detecting the grid line 3, and detects the grid line 3 for the robot 1 to move along. Accordingly, at least one light sensor 16 detects the predetermined path in a predetermined area of the field 2 in order for the robot 1 to move along the grid lines 3 indicating the predetermined path.

Furthermore, a pair of crawlers 17 are provided on the bottom surface of the main body 1a with the antenna 15 therebetween. Each crawler 17 has an endless track which is independently driven, and the robot 1 is capable of not only traveling forward and traveling backward but also turning in the left and right direction about the center of the bottom surface.

FIG. 4 is a block diagram illustrating a configuration of the hardware circuit of the robot 1.

A robot control unit 21, an NFC reader/writer (NFC R/W) circuit 22, four light sensor drive circuits 23, two crawler drive circuits 24, a user interface control unit (hereinafter, UI control unit) 25, and an external connection device 26 are provided in the main body 1a of the robot 1. Furthermore, a battery 27 such as a secondary battery for supplying electric power to each part in the main body 1a are built in the main body 1a of the robot 1.

The robot control unit 21 includes a processor 21a, an image processing unit 21b, and a memory 21c. The processor 21a includes a central processing unit (CPU), ROM, RAM and the like, and can read and execute various programs stored in the ROM.

The image processing unit 21b is a circuit that receives image signals from the four light sensors 16 and performs predetermined image processing. Here, the image processing unit 21b performs processing items for detecting the presence or absence of the grid line 3, and the position and moving direction on the grid line 3.

The memory 21c is a non-volatile memory in which operation programs, internal variables, and the like are stored. As described later, the internal variables can be referenced by the operation program.

The NFC reader/writer circuit 22 is a circuit that is connected to the antenna 15, and reads the operation program and the like stored in the NFC tag 4 or writes the operation program and the like into the NFC tag 4 through a contactless wireless communication with the NFC tag 4 under the control of the robot control unit 21. That is, the NFC reader/writer circuit 22 wirelessly reads the operation program from the NFC tag 4. In other words, the NFC reader/writer circuit 22 reads the operation program from the NFC tag 4 provided on the predetermined path.

In addition, as described below, the NFC reader/writer circuit 22 can also write data into the NFC tag 4 in accordance with the operation program.

The light sensor drive circuit 23 is a circuit that drives the four light sensors 16 and receives the image signals from the light sensor 16 and outputs the signals to the robot control unit 21.

The crawler drive circuit 24 outputs two drive signals for driving the pair of crawlers 17 to two motors 17a that move the pair of crawlers 17, under the control of the robot control unit 21.

The UI control unit 25 is a circuit that transfers the input signals from the keyboard 11 and the button unit 14 described above to the robot control unit 21 and outputs a display signal from the robot control unit 21 to the display 12 and the indicator unit 13. The UI control unit 25 may include a processor such as a CPU.

The external connection device 26 is a communication interface for communicating with the external device. Here, the external connection device 26 is a communication circuit for the Bluetooth® communication and the WIFI communication. The external connection device 26 is used for updating the internal software program of the robot 1.

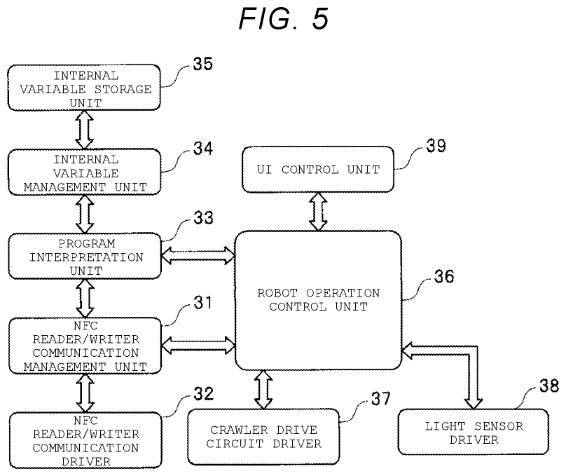

FIG. 5 is a configuration diagram of the internal software program for the robot control unit 21 of the robot 1.

The internal software program for the robot control unit is stored in the ROM of the processor 21a of the robot control unit 21.

The internal software program for the robot control unit achieves the functions of an NFC reader/writer communication management unit 31, an NFC reader/writer communication driver 32, a program interpretation unit 33, an internal variable management unit 34, an internal variable storage unit 35, a robot operation control unit 36, a crawler drive circuit driver 37, a light sensor driver 38, and a UI control unit 39.

The internal software program for the robot control unit 21 is a program in which a basic operation for the robot 1 to read the operation program from the NFC tag 4 and to execute is described.

The NFC reader/writer communication management unit 31 is a program for communicating with the NFC tag 4 via the NFC reader/writer communication driver 32. The NFC reader/writer communication driver 32 is also a program.

Specifically, the NFC reader/writer communication management unit 31 performs managements of the NFC reader/writer circuit 22 for the transmission of the commands to detect the NFC tag 4 and to read the tag data, and for the reception of the response thereof. Furthermore, the NFC reader/writer communication management unit 31 also acquires the operation program written in an NFC data exchange format (NDEF format) as text data from the NFC tag 4.

The NFC reader/writer communication management unit 31 may transmit an instruction to stop the robot 1 to the robot operation control unit 36 in order to take a sufficient time to read the NDEF data when the NFC tag 4 is detected.

The text data acquired by the NFC reader/writer communication management unit 31 is sent to the program interpretation unit 33.

The program interpretation unit 33 performs parsing processing on the text data to cut out reserved words, operators, internal variables, immediate values, and the like, and then, performs interpretation of the control structure of the program, interpretation of the robot control instructions, and calculation processing for the internal variables.

That is, the program interpretation unit 33 interprets the command included in the operation program read by the NFC reader/writer circuit 22.

The internal variables are stored in the memory 21c by the internal variable storage unit 35, and the internal variable management unit 34 refers to, computes, and stores the internal variables according to the processing for the internal variables described in the program.

When a control command relating to the operation of robot 1 is detected, the program interpretation unit 33 notifies the robot operation control unit 36 of the detection.

The robot operation control unit 36 receives the moving direction and the moving amount of the robot 1 from the program interpretation unit 33, and controls the pair of crawlers 17 via the crawler drive circuit driver 37. The crawler drive circuit driver 37 is also a program.

The robot operation control unit 36 recognizes the grid line 3 based on the image signal from one light sensor 16 via the light sensor driver 38. The light sensor driver 38 is also a program.

Specifically, the robot operation control unit 36 recognizes that the four light sensors 16 detect the grid line 3 using the image processing unit 21b, and detects the moving amount on the grid line 3 at the time of traveling forward and at the time of traveling backward, and a rotational movement angle at the time of the rotation. The robot operation control unit 36 controls to stop the operation of each crawler 17 when it reaches a specified moving amount.

At the time of traveling forward time or traveling backward, the robot operation control unit 36 performs a servo control on the movement in the traveling direction based on the detection of the grid line 3 by the pair of light sensors 16 along the traveling direction.

The UI control unit 39 monitors the signal of the button unit 14 of the main body 1a, and notifies the robot operation control unit 36 of the detection of the pressing of the program execution button (Go) 14b so as to start the operation of robot 1.

Furthermore, the UI control unit 39 monitors the input to the keyboard 11, and outputs the display data to the display 12, and also performs the display processing on the indicator unit 13.

### (Action)

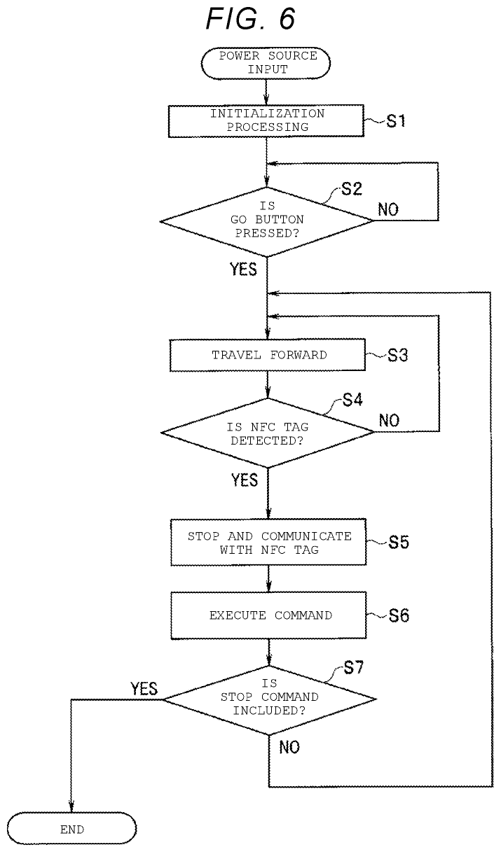

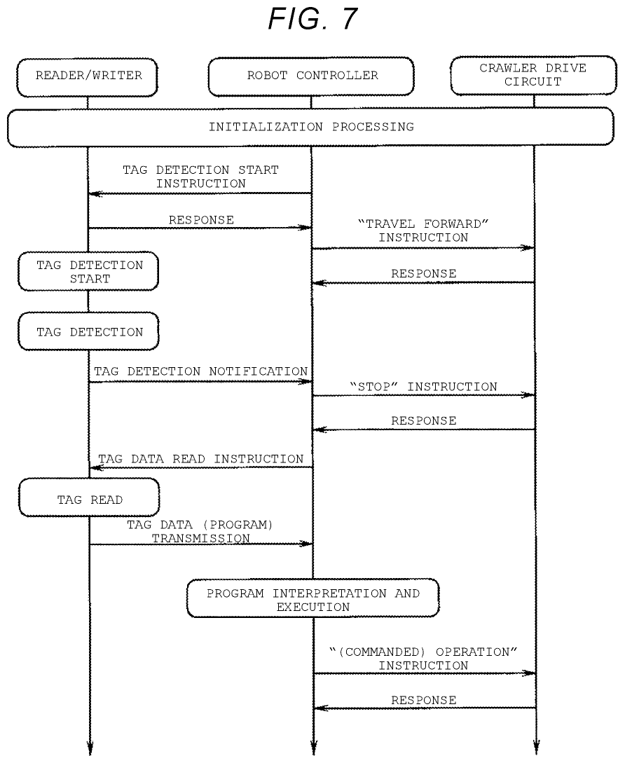

Next, the operation of robot 1 will be described with reference to FIG. 6 and FIG. 7.

FIG. 6 is a flowchart illustrating an example of a flow of the basic operation of the robot 1. FIG. 7 is a sequence diagram illustrating messaging between the NFC reader/writer circuit 22 of the NFC tag 4, the robot control unit 21, and a crawler drive circuit 24 when the robot 1 is traveling forward and detects the NFC tag 4.

The program for the processing in FIG. 6 is a program stored in the robot operation control unit 36, read and executed by the CPU of the processor 21a.

The processing in FIG. 6 is performed when the power source button 14a is pressed and the power source of the robot 1 is turned on.

When the power source of the robot 1 is turned on, first, the processor 21a performs the initialization processing for the device of the robot 1 (step1 (“step” hereinafter abbreviated as “S”)).

After the initialization processing, the processor 21a determines whether or not the program execution button (Go) 14b is pressed (S2).

If the program execution button (Go) 14b is not pressed (NO in S2), nothing is done in the processing.

When the program execution button (Go) 14b is pressed (YES in S2), the processor 21a causes the robot 1 to travel forward (S3). Specifically, the processor 21a outputs a control signal to output a drive signal for driving the motor 17a to the crawler drive circuit 24 in order to cause the robot 1 to travel forward. The robot control unit 21 gives an instruction command of “travel forward” to the crawler drive circuit 24 and the crawler drive circuit 24 transmits a response signal to the robot control unit 21, and then, the robot 1 is caused to travel forward.

At the same time, the processor 21a transmits a start signal to the NFC reader/writer circuit 22 to start polling, that is, gives a tag detection start instruction command. As illustrated in FIG. 7, when the tag detection start instruction command is given to the NFC reader/writer circuit 22, the robot control unit 21 receives a response signal from the NFC reader/writer circuit 22. Thereafter, the NFC reader/writer circuit 22 starts detecting the NFC tag 4.

The processor 21a determines whether or not the NFC tag 4 is detected (S4).

When the NFC tag 4 is detected, the NFC reader/writer circuit 22 outputs a tag detection notification signal to the robot control unit 21.

If the NFC tag 4 is not detected (NO in S4), the process returns to S3 and the robot 1 travels forward until the NFC tag 4 is detected.

When the NFC tag 4 is detected (YES in S4), the processor 21a stops the robot 1, communicates with the NFC tag 4, and reads a control command, that is, an operation program, from the NFC tag 4 (S5).

Specifically, since the tag detection notification signal is received, the processor 21a transmits a control signal of “stop” instruction for stopping the robot 1 to the crawler drive circuit 24. In response to the control signal of the “stop” instruction, the crawler drive circuit 24 outputs the response signal to the processor 21a and stops the operation of the pair of crawlers 17.

After the robot 1 stops, the processor 21a controls the NFC reader/writer circuit 22 to communicate with the NFC tag 4, and read the operation program from the NFC tag 4. Specifically, the processor 21a transmits a tag data read instruction signal to the NFC reader/writer circuit 22. In response to the tag data read instruction signal, the NFC reader/writer circuit 22 reads tag data, that is, the operation program, from the NFC tag 4 and transmits the operation program to the processor 21a.

The communication between the processor 21a and the NFC tag 4 is performed based on a protocol prescribed in ISO 14443 which is an international standard of low power IC communication technology (RFID), for example.

Here, an example of the command written into the NFC tag 4 will be described.

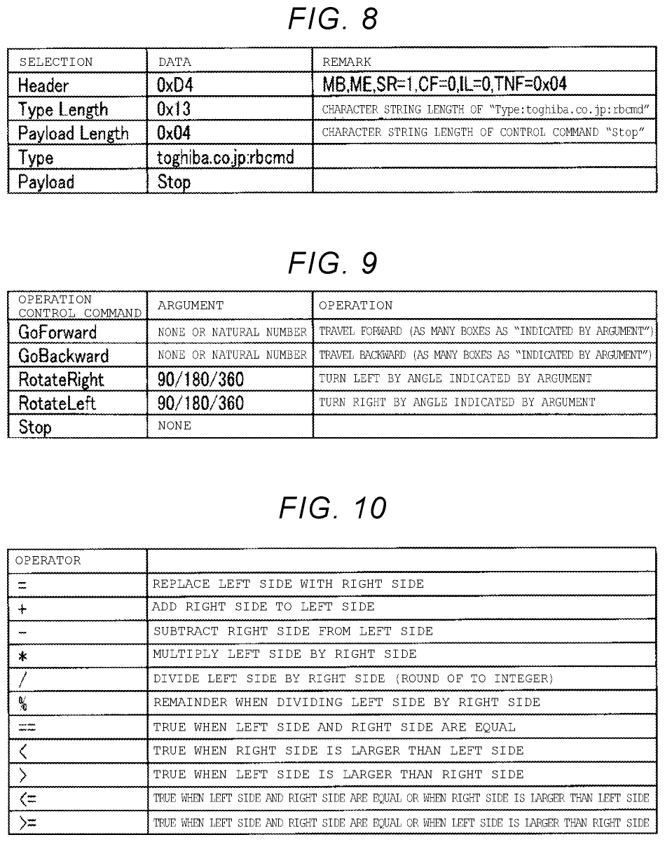

FIG. 8 is a diagram showing an example of a data structure of tag data stored in the NFC tag 4.

Data described in the NDEF is recorded in the NFC tag 4. For the NDEF, refer to “NFC Data Exchange Format (NDEF) Technical Specification” from the NFC Forum.

The NFC tag 4 has a data structure illustrated in FIG. 8. Here, as illustrated in FIG. 8, it is assumed that “TNF” of NFC tag 4 uses “0x04” (NFC Forum external type) and “Type” is defined as “toghiba.co.jp: rbcmd”.

Content of the NDEF in the NFC tag 4 is assumed to be described in ASCII code. In FIG. 8, a command “stop” is written into “Payload” as the text data.

After finishing editing the operation program, the user may press the tag write button (Sc) 14c for programming while allowing the NFC reader/writer circuit 22 at the bottom portion of the main body 1a to detect the NFC tag 4, so that the edited operation program can be written into the NFC tag 4 in the NDEF whose “Type” is “toghiba.co.jp: rbcmd”.

In addition, similarly, editing and writing of the data are also possible. While allowing the NFC reader/writer circuit 22 at the bottom portion of the main body 1a to detect the NFC tag 4, the user may press the tag write button (Sd) 14e for programing, so that the edited data can be written into the NFC tag 4 in the NDEF format whose “Type” is “toghiba.co.jp: rbcmd”.

Furthermore, it is also possible to read the operation program and the data already written in the NFC tag 4. While allowing the NFC reader/writer circuit 22 at the bottom portion of the main body 1a to detect the NFC tag 4, the user may press the tag read button (Ld) 14c, so that the NDEF data of the NFC tag 4 can be read out and the readout content can be displayed on the display 12 when the “Type” is “toghiba.co.jp: rbcmd” or the “Type” is “toghiba.co.jp: rbdata”. The user may also edit the displayed program and the data again and write the result into the tag.

FIG. 9 is a diagram illustrating a list of the commands. Hereinafter, the description will be made using an example of reserved words of the program syntax.

There are various commands in the command, here, there are operation control commands relating to the movement of the robot 1 such as traveling forward and traveling backward. Furthermore, as for the rotation of the robot 1, there are operation control commands such as right rotating and left rotating, which respectively relates to the rotation of 90 degrees, 180 degrees and 360 degrees. Furthermore, as the operation control commands, there is an operation control command for stopping the robot 1 as well.

In addition, operators may also be used for the command. FIG. 10 is a diagram illustrating a list of the operators. The command may include operators for addition, subtraction, multiplication, division, and comparison using the internal variables.

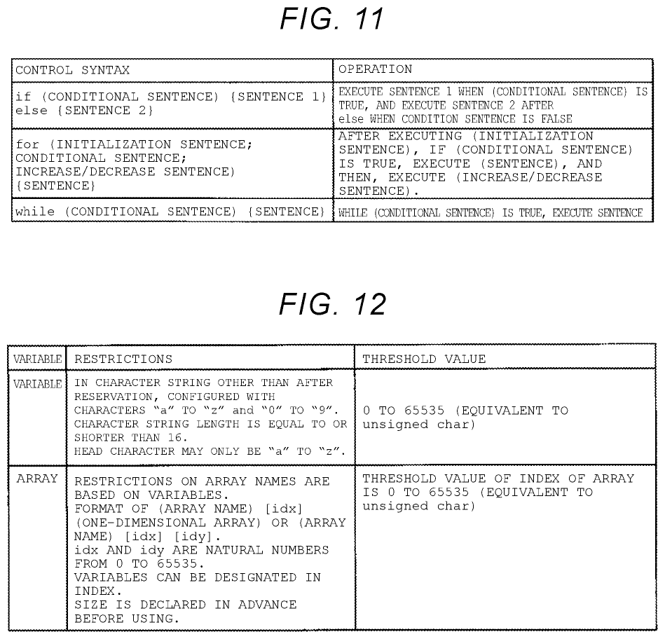

Furthermore, the command may include the syntax of the program execution control system for conditional branching and loop processing using the internal variables. FIG. 11 is a diagram illustrating a list of control syntax.

For example, numeric data may take a value in the range of 0 to 65535.

In addition, the variables and array data may be used for the command. FIG. 12 is a diagram illustrating definitions of usable variables and arrays.

Under the rules described above, the robot 1 can write an operation program including the command into the NFC tag 4.

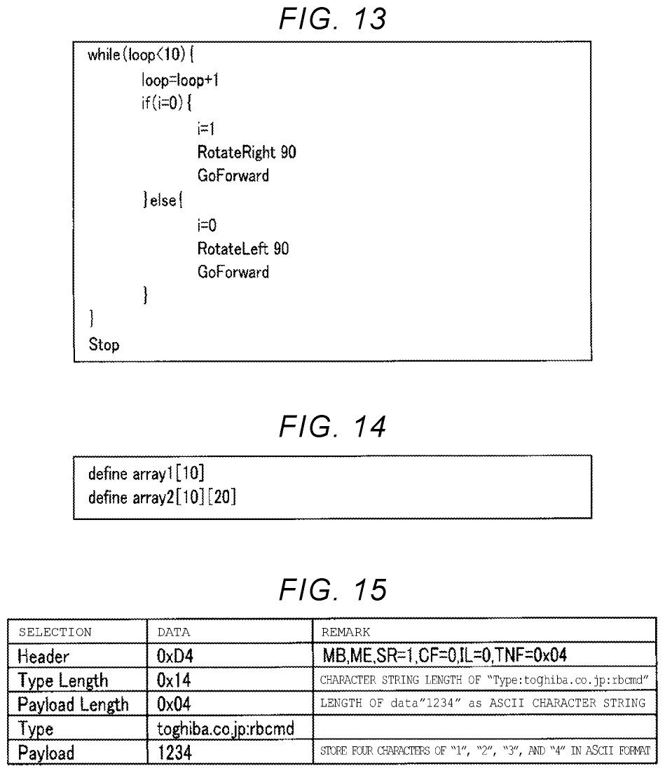

FIG. 13 is a diagram illustrating an example of the operation program. The operation program illustrated in FIG. 13 is a program for the operation of traveling forward after turning right or left according to the value of internal variable i.

In principle, the operation program is described only as one sentence in one line ending with a line feed code. In a case of the control syntax, it is permissible to span multiple lines.

In addition, each reserved word is delimited by a “space” as a delimiter. As illustrated in FIG. 13, the operation program stored in the NFC tag 4 may include a plurality of sentences. The length of the operation program stored in the NFC tag 4 depends on the write capacity of the NFC tag 4, but the operation program including the control command written into one NFC tag 4 is completed within the NFC tag 4. For example, it is not possible to divide one sentence and enter the parts in a plurality of NFC tags 4 such as writing “if (conditional statement) {” into the first NFC tag 4 and writing “(execution statement)}” into the next NFC tag 4.

Furthermore, it is assumed that the internal variables may be made available without declaration, and the initial value will be “0”. In a case of using the array, it is assumed that it is necessary to declare the size in advance.

FIG. 14 is a diagram illustrating an example of declaring the size of arrays.

Returning to FIG. 6, the processor 21a executes the command included in the operation program read from the NFC tag 4 (S6). Specifically, the processor 21a interprets the command included in the operation program using the program interpretation unit 33, and executes the interpreted command. For example, the processor 21a transmits the control signal instructing the operation according to the command to the crawler drive circuit 24. In response to each received control signal, the crawler drive circuit 24 transmits the response signal to the processor 21a.

That is, the processing in S6 configures an execution unit for executing the interpreted command.

After executing the command in the operation program, the processor 21a determines whether or not the stop command is included in the operation program (S7).

When the stop command is included (YES in S7), the processing ends. That is, the robot 1 stops the operation.

When the stop command is not included (NO in S7), the processing returns to S3, and the robot 1 travels forward until an NFC tag 4 is detected.

Therefore, when the robot 1 detects an NFC tag 4, the robot 1 stops. The robot 1 communicates with the NFC tag 4, reads the operation program, and executes each command included in the operation program. The robot 1 stops when the operation program includes the stop command. When the stop command is not included in the operation program, the robot 1 travels forward until the robot 1 detects an NFC tag 4.

As described above, according to the above-described embodiment, the robot 1 can read the operation program stored in an NFC tag 4 placed on the moving path, recognize the included command, and perform the operation according to the command.

In the embodiment described above, the robot 1 reads the operation program from the NFC tag 4 and performs the operation based on the operation program, for example performing a movement. However, the robot 1 may further perform an operation of writing data into the NFC tag 4.

FIG. 15 is a diagram illustrating an example of the data structure of the NFC tag 4, for the tags used for reading and writing the data to and from the NFC tag 4.

Here, as in the case of command and as illustrated in FIG. 15, it is assumed that “TNF” of the NFC tag 4 uses “0x04” (NFC Forum external type) and “Type” is defined as “toghiba.co.jp: rbcmd”.

Here, four values of 1, 2, 3, and 4 are written in the ASCII code as the value of data written into the NFC tag 4, and are stored in a “Payload”. Here again, the values of data may be in a range from 0 to 65535.

Here, a command for storing the data read from the NFC tag 4 in variables or in an array, and a command for writing the variable or the array data into the NFC tag 4 are newly defined.

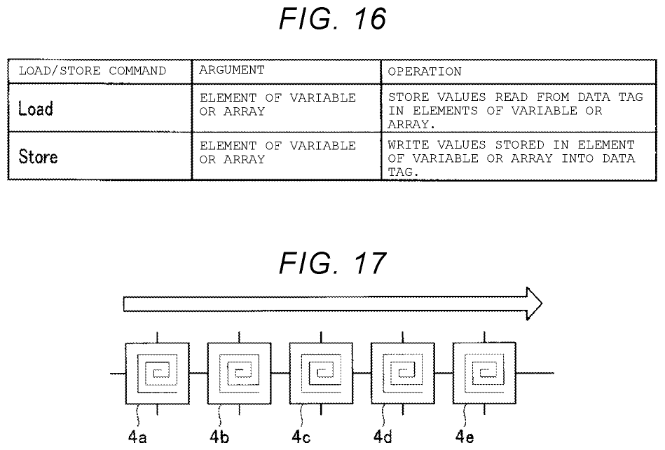

FIG. 16 is a diagram illustrating an example of the command for storing and writing. FIG. 16 illustrates the data load command and the data store command.

Here, it is possible to visualize the process in which the robot 1 performs the data handling during the operation using the NFC tag 4 and two commands.

FIG. 17 is a diagram illustrating an example of the arrangement of a plurality of NFC tags 4.

For example, as illustrated in FIG. 17, five NFC tags 4 are arrayed on one line of the grid line 3.

The NFC tags 4a, 4b, 4c, 4d, and 4e are sequentially arranged on the field 2 along the traveling direction of the robot 1. The NFC tag 4a is a program tag in which an operation program is stored. The NFC tags 4b to 4e are data tags in which the data items are stored.

Here, the NFC tags 4 are arrayed as illustrated in FIG. 17, and the robot 1 performs the operations of sorting the data written in each data tag in ascending order, and writing the sorted result into the data tag.

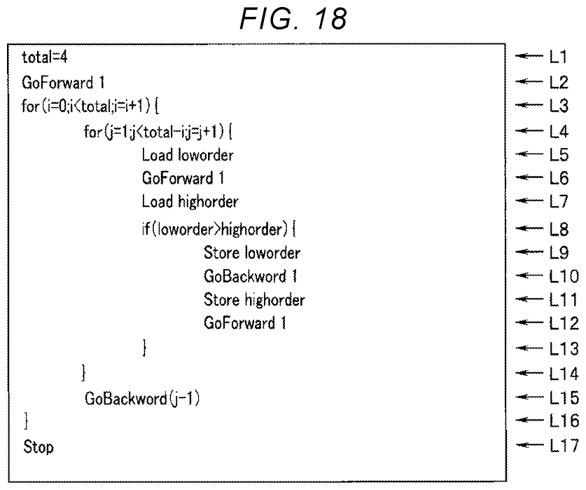

FIG. 18 is a diagram illustrating an example of the operation program written in the NFC tag 4a which is a program tag.

The operation program illustrated in FIG. 18 is a sort program. The processing in FIG. 18 will be described.

In a line L1, the number of data tags is assigned to the variable “total”. Here, 4 is assigned to the variable “total”.

In a line L2, since the data tags are placed behind the NFC tag 4a, the robot 1 travels forward one grid box to read the data tag.

In this example, since the sorting algorithm is a bubble sorting algorithm, the data tag is read and compared in a double “for loop” starting from lines L3 to L4.

In line L8, the values of the two read tags are compared.

In lines L9 to L12, if the values are in reverse order, the data of the two tags are rewritten.

In line L15, after the “for loop” in L4 ends, since the robot 1 is at the position of the jₜₕ data tag, the data is read again from the position of the NFC tag 4b in FIG. 17, and the robot 1 travels backward as much as (j-1) grid boxes to perform the comparison.

After the above program ends, the initial data is sorted in the data tags 4b to 4e in an ascending sorted order.

In the process of sorting, since the robot moves to the position of each tag, and then reads and writes the data, the process of sorting can be visually recognized. In addition, in this example, the bubble sorting algorithm is used, but by using another sorting algorithm, it is possible to recognize the difference of algorithms as the movement of the robot. Therefore, it is possible to promote the understanding of algorithms for the sake of programming education.

As described above, according to the above-described embodiment, it is possible to provide a self-traveling device and a self-traveling device system capable of performing complicated operations without downloading a rewriting program.

The robot 1 in the embodiment described above is effective for programming education.

In recent years, there has been growing interest in intellectual toys and educational toys that give preschool children an opportunity to receive programming education. In products such as these intellectual toys, and services using these products, besides using a general-purpose PC, a portable information terminal (PDA: Personal Digital Assistant), a smartphone, or a tablet terminal, there is a system for performing the programming and learning experiences using the self-traveling robot.

In such a system, it is necessary to use some methods to cause the robot to read the “program” for controlling the operation and behavior of the robot operation. One method is to upload the “program” created by the PC, smartphone or tablet terminal to the robot main body using a communication method. When using this method, it is possible to control the robot with higher accuracy, and further, it becomes necessary to thoroughly learn the operation of PC, smartphone, and tablet terminal, or some knowledges of programming is needed.

Another way of causing the robot to read the “program” may include causing a robot to read a card or the like in which a relatively simple command is written, without using the PC or the like. In this method, the creation of “program” to be read into the robot does not require the familiarity with the operation of the PC or the like and the knowledge of programming, but the command written on the card is limited to a simple command.

In addition, when updating the basic software configuring the robot system or upgrading the robot system or the like, and if the robot's capable operations increase, it is difficult to prepare a card enabling the operation. For example, even if a general two-dimensional bar code is used, since it is necessary to separately prepare a device for displaying the two-dimensional barcode as printing or an image, the cost of the robot system may be greatly increased.

In addition, by merely receiving a read-only card such as a two-dimensional barcode as an input, information such as the state during operation and internal variables cannot be saved outside the robot. Therefore, the internal variables, states, or the like exist only within the robot, and cannot be exposed to the outside. In other words, the robot operates like a black box, and thus, when this is used for programming education, it is difficult to increase the understanding of the program.

On the other hand, according to the embodiment described above, by using the above-described self-traveling device, it is possible to achieve a programming education system with high degree of freedom and extensibility without the problems described above, using a near field wireless tag such as the NFC tag 4 as a method of inputting commands to the robot 1.

In particular, the user can experience the sequence of commands and the corresponding operations using the self-traveling robot 1.

In addition, since the storage capacity, that is, the information amount of the near field wireless tag is larger than that of the two-dimensional bar code, it is possible to include a plurality of complicated commands for the precise operations in the operation program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A self-traveling device propelled by a motor, comprising:
a tag reader/writer configured to communicate with a wireless tag; and
a processor configured to:
control the motor to propel the device toward a position where the wireless tag is placed,
when the device reaches the position, in response to receipt of an operation program from the wireless tag through the tag reader/writer, interpret a command included in the operation program, and
execute the interpreted command before controlling the motor to propel the device toward another position where another wireless tag is placed.

2. The self-traveling device according to claim 1, wherein
the processor is configured to repeat the motor control, the command interpretation, and the command execution until the tag reader/writer receives the operation program including a stop command.

3. The self-traveling device according to claim 1, wherein the processor is configured to
detect a line on a driving surface and
control the motor to propel the device along the detected line.

4. The self-traveling device according to claim 3, further comprising:
one or more light sensors configured to detect the line on the driving surface, wherein
the line is a part of grid lines drawn on the driving surface.

5. The self-traveling device according to claim 3, wherein
the tag reader/writer is configured to communicate with the wireless tag placed on the line.

6. The self-traveling device according to claim 1, further comprising:
a memory that stores internal variables referred to by the operation program.

7. The self-traveling device according to claim 1, wherein
the processor is configured to control the tag reader/writer to write data into the wireless tag according to the interpreted command.

8. The self-traveling device according to claim 1, further comprising:
a keyboard configured to receive an input of a program code, wherein
the processor is configured to operate the device according to the input program code.

9. The self-traveling device according to claim 8, further comprising:
a display configured to display the input program code.

10. The self-traveling device according to claim 1, wherein the wireless tag is a near field communication (NFC) tag.

11. A self-traveling device system comprising:
a plurality of wireless tags; and
a self-traveling device comprising:
a tag reader/writer configured to communicate with a wireless tag; and
a processor configured to:
control the motor to propel the device toward a position where the wireless tag is placed,
when the device reaches the position, in response to receipt of an operation program from the wireless tag through the tag reader/writer, interpret a command included in the operation program, and
execute the interpreted command before controlling the motor to propel the device toward another position where another wireless tag is placed.

12. The system according to claim 11, wherein
the processor is configured to repeat the motor control, the command interpretation, and the command execution until the tag reader/writer receives the operation program including a stop command.

13. The system according to claim 11, wherein
the processor is configured to detect a line on a driving surface and control the motor to propel the device along the detected line.

14. The system according to claim 13, further comprising:
one or more light sensors configured to detect the line on the driving surface, wherein
the line is a part of grid lines drawn on the driving surface.

15. The system according to claim 13, wherein
the tag reader/writer is configured to communicate with the wireless tag placed on the line.

16. The system according to claim 11, further comprising:
a memory that stores internal variables referred to by the operation program.

17. The system according to claim 11, wherein
the processor is configured to control the tag reader/writer to write data into the wireless tag according to the interpreted command.

18. The system according to claim 11, further comprising:
a keyboard configured to receive an input of a program code, wherein
the processor is configured to operate the device according to the input program code.

19. The system according to claim 18, further comprising:
a display configured to display the input program code.

20. A method for controlling a self-traveling device propelled by a motor, the method comprising:
controlling the motor to propel the device toward a position where a wireless tag is placed;
when the device reaches the position, receiving an operation program from the wireless tag;
interpreting a command included in the operation program; and
executing the interpreted command before controlling the motor to propel the device toward another position where another wireless tag is placed.
